(19) United States
(12) Patent Application Publication
(10) Pub. No.: US 2017/0297508 A1
(43) Pub. Date: Oct. 19, 2017

(54) IRIDESCENT BADGES WITH EMBOSSED DIFFRACTION FILMS FOR VEHICLES AND METHODS OF MAKING THE SAME

(71) Applicant: Ford Global Technologies, LLC, Dearborn, MI (US)

(72) Inventors: Paul Kenneth Dellock, Northville, MI (US); Stuart C. Salter, White Lake, MI (US)

(73) Assignee: Ford Global Technologies, LLC, Dearborn, MI (US)

(21) Appl. No.: 15/290,235

(22) Filed: Oct. 11, 2016

Related U.S. Application Data
(63) Continuation-in-part of application No. 15/132,732, filed on Apr. 19, 2016.

(51) Int. Cl. B60R 13/00; B29C 45/14; B29D 11/00; B29C 59/02; G02B 27/42; B29L 31/00

(52) U.S. Cl. CPC B60R 13/005; B29C 59/022; G02B 27/4233; B29C 45/14336; B29D 11/00769; B29L 2031/744; B29K 2995/0029

(57) ABSTRACT

A method of making an iridescent badge that includes: embossing a diffraction grating into a polymeric film to form a diffraction film; positioning the diffraction film in a mold; and injecting a translucent polymeric material into the mold over the diffraction film to form a vehicular badge. Further, the diffraction grating has a thickness from 250 nm to 1000 nm and a period from 50 nm to 5 microns. Another method of making an iridescent badge includes: heating a diffraction film positioned in a mold; applying a vacuum to form the film against a mold surface; and injecting a translucent polymeric material over the mold surface to form a vehicular badge. Further, the diffraction film comprises a polymeric material and a diffraction grating having a thickness from 250 nm to 1000 nm and a period from 50 nm to 5 microns.

### CROSS REFERENCE TO RELATED APPLICATION

This application is a continuation-in-part application that claims priority to and the benefit under 35 U.S.C. §120 of U.S. patent application Ser. No. 15/132,732, filed Apr. 19, 2016, entitled “Iridescent Badges for Vehicles and Methods of Making the Same,” the disclosure of which is hereby incorporated by reference in its entirety.

### FIELD OF THE INVENTION

The present invention generally relates to iridescent badges, trim and other exterior surfaces for vehicles and methods of making the same, particularly automotive badges with a jewel-like appearance.

### BACKGROUND OF THE INVENTION

Car enthusiasts and owners of luxury and high-end vehicles are continually demanding new aesthetics that justify, at least in part, the high cost of such vehicles. Vehicle badges can be designed to reflect the luxury and high-end nature of particular vehicle models. For example, certain vehicle models can be more desirable to car enthusiasts and owners with a badge having a jewel-like appearance.

The direct incorporation of jewels and/or precious metals into a vehicle badge can satisfy these needs in some respects. These elements might be encapsulated within a translucent badge for a luxurious aesthetic. Nevertheless, merely adding jewels and precious metals to conventional badges will significantly increase the cost of the badge, and all but the most cost-insensitive car enthusiasts will likely object to the significant added cost of these materials. In addition, the inclusion of jewels and/or precious metals into a vehicular badge increases the likelihood that it will be removed by thieves as a target of relative opportunity.

Other approaches to upgrading the aesthetics of vehicle badges have focused on mimicking the look of diamonds and jewels within a molded plastic part. For example, it is feasible to make faceted, plastic badges that attempt to approximate the look of actual diamonds and jewels. Unfortunately, the results of such approaches are not promising. Generally, such badges appear to look like costume jewelry and, arguably, could detract from the overall aesthetic of a luxury vehicle rather than enhance it.

Accordingly, there is a need for vehicular badges, trim and other exterior surfaces (and methods of making them) that exhibit an iridescent or jewel-like appearance without a significant cost increase associated with the enhancement. In addition, these iridescent, vehicular badges should maintain their appearance over a vehicle lifetime while being exposed to a typical vehicular environment. Further, these badges should be amenable to low-cost manufacturing approaches given their usage in vehicular applications as an end product with an expected large manufacturing volume.

### SUMMARY OF THE INVENTION

According to one aspect of the present invention, an iridescent vehicle badge is provided that includes a translucent, polymeric badge having a non-planar shape and comprising an interior and an exterior surface. Further, at least one of the surfaces of the badge is non-planar and comprises a diffraction grating integral with the badge, the grating having a thickness from 250 nm to 1000 nm and a period from 50 nm to 5 microns.

According to another aspect of the present invention, an iridescent vehicle badge is provided that includes a translucent, polymeric badge having a non-planar shape and comprising an interior and an exterior surface. Further, at least one of the surfaces of the badge comprises a plurality of diffraction gratings that are integral with the badge, each having a thickness from 250 nm to 1000 nm and a varying period from 50 nm to 5 microns.

According to a further aspect of the present invention, a method of making an iridescent vehicle badge is provided that includes the steps: forming a mold with mold surfaces corresponding to interior and exterior surfaces of the badge; ablating at least one of the mold surfaces to form a diffraction grating mold surface; and forming the badge with a diffraction grating having a thickness from 250 nm to 1000 nm and a period from 50 nm to 5 microns in the mold surfaces with a polymeric material.

According to an additional aspect of the present invention, an iridescent badge is provided that includes a translucent, polymeric badge comprising interior and exterior surfaces, the badge formed from multiple parts. Further, at least one of the surfaces is planar or non-planar and comprises a diffraction grating, the diffraction grating having a thickness from 250 nm to 1000 nm and a period from 50 nm to 5 microns.

According to a further aspect of the present invention, a method of making an iridescent badge is provided that includes the steps: embossing a diffraction grating into a polymeric film to form a diffraction film; positioning the diffraction film in a mold; and injecting a translucent polymeric material into the mold over the diffraction film to form a vehicular badge. Further, the diffraction grating has a thickness from 250 nm to 1000 nm and a period from 50 nm to 5 microns.

According to an additional aspect of the present invention, a method of making an iridescent badge is provided that includes the steps: heating a diffraction film positioned in a mold; applying a vacuum to form the film against a mold surface; and injecting a translucent polymeric material over the mold surface to form a vehicular badge. Further, the diffraction film comprises a polymeric material and a diffraction grating having a thickness from 250 nm to 1000 nm and a period from 50 nm to 5 microns.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a front perspective view of an iridescent vehicular badge affixed to the front of a vehicle according to an aspect of the disclosure;

FIG. 2 is a top-down, schematic plan view of an iridescent vehicular badge according to an aspect of the disclosure;

FIG. 2A is a cross-sectional, schematic view of the badge depicted in FIG. 2 through line IIA-IIA;

FIG. 2B is an enlarged, cross-sectional schematic view of a diffraction grating incorporated into an interior surface of the badge depicted in FIG. 2;

FIG. 2C is a cross-sectional, schematic view of the badge depicted in FIG. 2 through line IIC-IIC, as configured with diffraction films;

FIG. 2D is an enlarged, cross-sectional schematic view of a diffraction film incorporated into an interior surface of the badge depicted in FIG. 2;

FIG. 3 is a top-down, schematic plan view of an iridescent vehicular badge with non-planar exterior and interior surfaces according to an aspect of the disclosure;

FIG. 3A is a cross-sectional, schematic view of the badge depicted in FIG. 3 through line IIIA-IIIA;

FIG. 3B is an enlarged, cross-sectional schematic view of a diffraction grating incorporated into a non-planar interior surface of the badge depicted in FIG. 3; and

FIG. 3C is a cross-sectional, schematic view of the badge depicted in FIG. 3 through line IIIC-IIIC, as configured with diffraction films;

FIG. 3D is an enlarged, cross-sectional schematic view of a diffraction film incorporated into an interior surface of the badge depicted in FIG. 3;

FIG. 4 is an enlarged, cross-sectional schematic view of a diffraction grating with a varying period;

FIG. 5 is a schematic of an embossing process and apparatus employed to emboss diffraction gratings into a polymeric film to form diffraction films;

FIG. 6 is a schematic of an insert molding process for making an iridescent vehicular badge, as depicted in FIGS. 2-2D and 3-3D; and

FIG. 7 is a schematic of an vacuum-assisted, insert molding process for making an iridescent vehicular badge, as depicted in FIGS. 2-2D and 3-3D

### DETAILED DESCRIPTION OF THE PREFERRED EMBODIMENTS

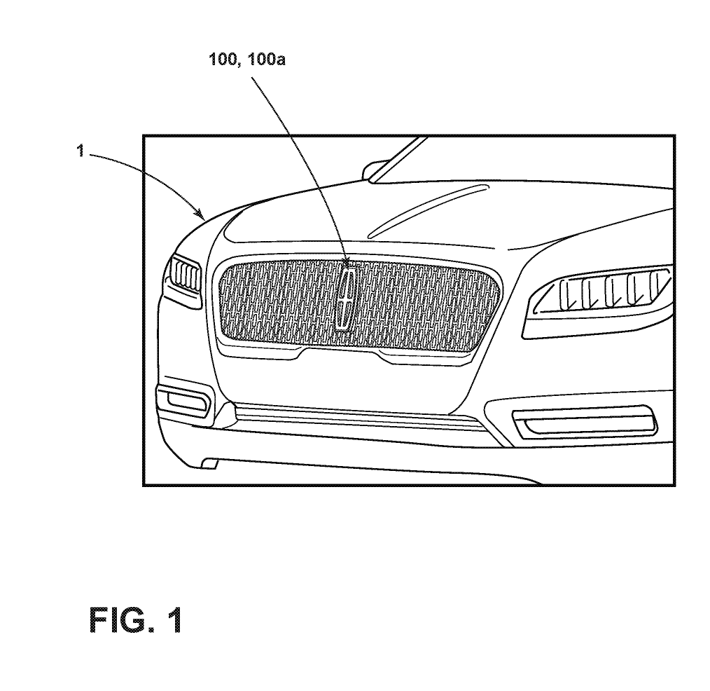

For purposes of description herein, the terms “upper,” “lower,” “right,” “left,” “rear,” “front,” “vertical,” “horizontal,” “interior,” “exterior,” “vehicle forward,” “vehicle rearward,” and derivatives thereof shall relate to the invention as oriented in FIG. 1. However, the invention may assume various alternative orientations, except where expressly specified to the contrary. Also, the specific devices and assemblies illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Described in this disclosure are iridescent badges, trim and other exterior surfaces (collectively, “iridescent vehicular elements”) for vehicles (and methods of making the same). The iridescent vehicular elements contain one or more diffraction gratings that are integral with the primary component(s) of the elements (e.g., a badge member), each of which provides sparkle and iridescence to the element. Alternatively, the diffraction gratings are part of films that are joined, bonded or otherwise incorporated into the badge member or comparable primary element. Various microscopic features can be added or adjusted within the gratings to achieve varied aesthetic effects. Gratings can also be incorporated into various regions within the vehicular element to achieve other varied, aesthetic effects. These gratings can also be embossed into films that are later incorporated into the badge member. Further, these iridescent badges, trim and other iridescent vehicular elements can be injection molded as one part, and typically cost only marginally more than conventional badges and trim. In addition, these badges, trim and other related vehicular elements can be insert molded from two or more parts (e.g., a badge member and a diffraction film), with or without vacuum assistance, with process costs that are only marginally higher than the process costs for conventional badges and trim.

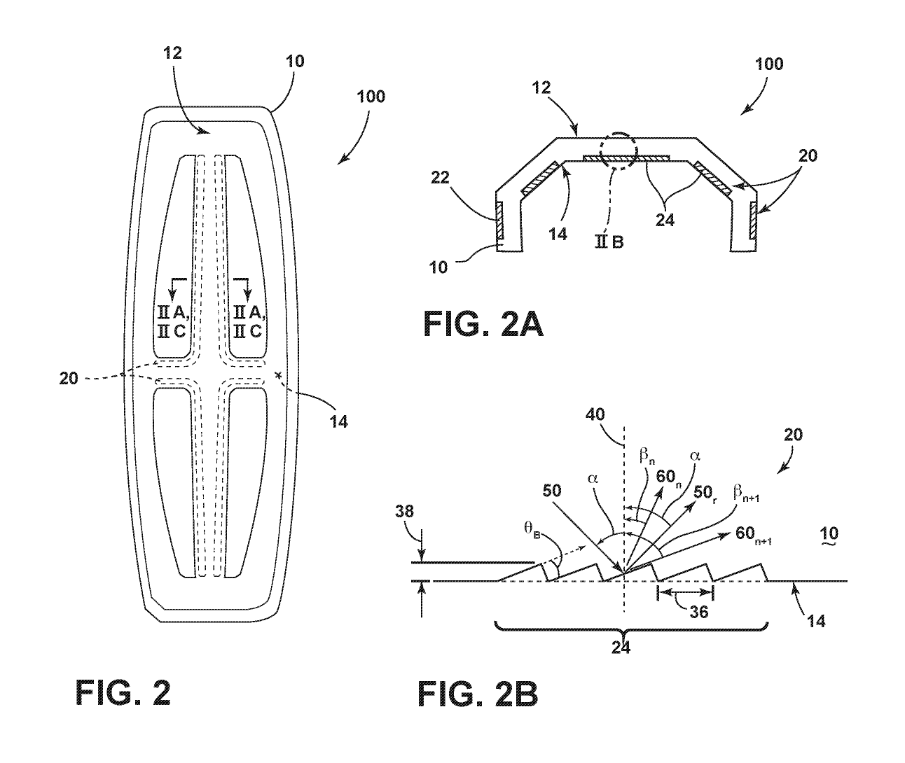

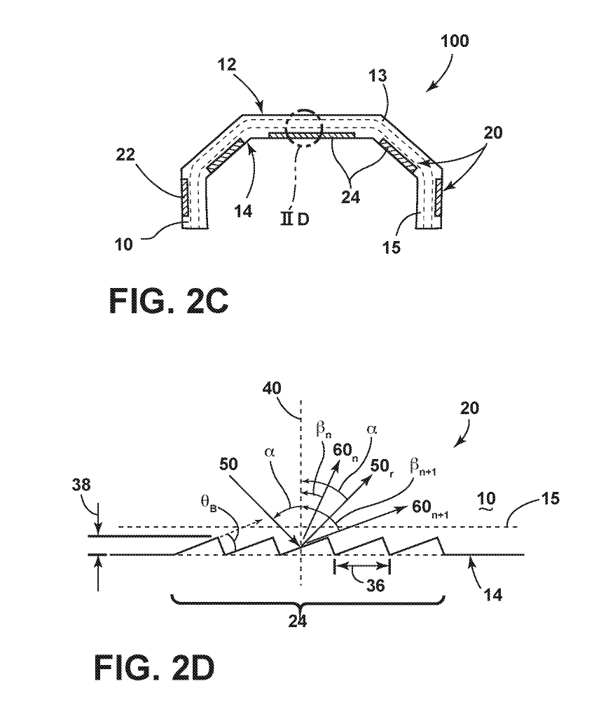

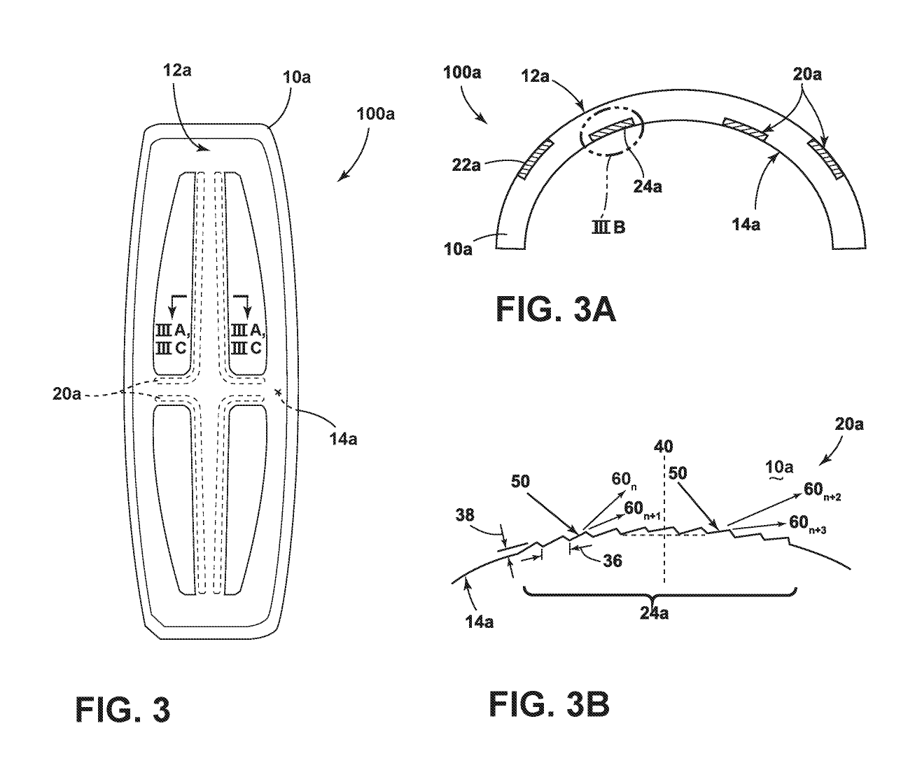

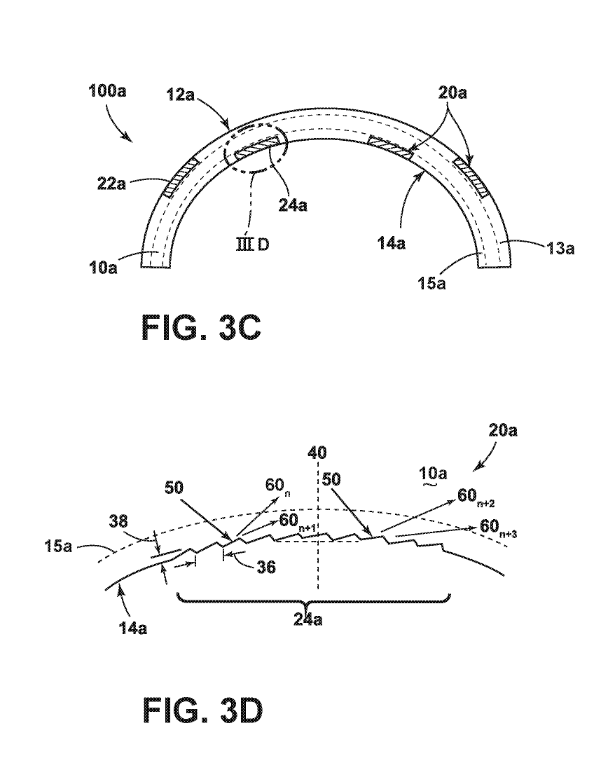

Referring to FIG. 1, a front perspective view of an iridescent vehicular badge 100, 100a affixed to the front of a vehicle 1 is provided according to an aspect of the disclosure. As depicted, the badge 100, 100a is characterized by an iridescent or jewel-like appearance under ambient lighting (e.g., from the sun). One or more diffraction gratings 20 (see FIGS. 2 and 3) configured within, or as part of a film that includes, an exterior and/or interior surface of the badge 100, 100a provide the iridescent or jewel-like appearance.

As shown in FIG. 2, an iridescent vehicular badge 100 can include a translucent, polymeric badge member 10. The badge member 10 includes one or more exterior surfaces 12 and one or more interior surfaces 14. In some aspects, the badge member 10 is characterized by an optical transmissivity of 85% or more over the visible spectrum (e.g., 390 to 700 nm). Preferably, the badge member 10 is characterized by an optical transmissivity of 90% or more, and even more preferably, 95% or more, over the visible spectrum. Further, the badge member 10 can be optically clear with no substantial coloration. In other embodiments, the badge member 10 can be tinted (e.g., with one or more colors, smoke-like effects, or other gradations and intentional non-uniformities) and/or affixed with one or more filters on its exterior surfaces 12 and/or interior surfaces 14 to obtain a desired hue (e.g., blue, red, green, etc.) or other effect.

Referring again to FIG. 2, the badge member 10 of the iridescent vehicular badge 100 is fabricated from a polymeric material. These polymeric materials include thermoplastic and thermosetting polymeric materials, e.g., silicones, acrylics and polycarbonates. In some embodiments, the precursor material(s) employed to fabricate the badge member 10 are selected to have a high flow rate and/or a low viscosity during a molding process such as injection molding. In other embodiments, the precursor material(s) employed to fabricate the badge member 10 are selected with higher viscosity levels based on cost or other considerations when a less viscosity-dependent process is employed, such as insert molding. In certain aspects, fillers (not shown), e.g., glass beads and particles, can be added to a polymeric material, serving as a matrix, to form the badge member 10 without significant detriment to the optical properties of the member. These fillers can provide added durability and/or additional aesthetic effects to the iridescent vehicular badge 100. Preferably, glass fillers are added in the range of 1 to 15% by volume, depending on the nature of the filler and the desired effect (e.g., enhanced durability, added light scattering, etc.).

The badge member 10 of the iridescent vehicular badge 100 can take on any of a variety of shapes, depending on the nature of the badge, vehicle insignia and other design considerations. For example, in some embodiments, one or more of the exterior and interior surfaces 12, 14 of the badge member 10 are planar (e.g., faceted), non-planar, curved or characterized by other shapes. As also understood by those with ordinary skill in the field, the exterior and interior surfaces 12, 14 can be characterized with portions having planar features and portions having non-planar features. As shown in FIGS. 2 and 2A, for example, the badge member 10 has planar (e.g., faceted) exterior and interior surfaces 12, 14 comprising diffraction gratings 20 as viewed in cross-section, while having some curved portions in forming the overall design of the vehicular badge 100.

Still referring to FIG. 2, the badge member 10 of the iridescent vehicular badge 100 can consist of a single component in a preferred embodiment. For example, the badge member 10 can be formed as a single piece with integral diffraction grating(s) 20 from a single mold. In other aspects, the member 10 can be formed from multiple parts, preferably with the parts joined, without significant detriment to the overall optical properties of the member 10. For example, in some of these embodiments, the vehicular badge 100 includes a badge member 10 and one or more diffraction films 13 and 15 (see FIGS. 2C, 2D).

Referring now to FIG. 2A, exterior and interior surfaces 12, 14 of the badge member 10 of the iridescent vehicular badge 100 include one or more diffraction gratings 20, preferably integral with the badge member 10. As depicted in exemplary fashion in FIG. 2A, the iridescent vehicular badge 100 includes a badge member 10 with exterior and interior surface diffraction gratings 22, 24 on planar portions of the exterior and interior surfaces 12, 14, respectively. Some aspects of the vehicular badge 100 include a badge member 10 with one or more diffraction gratings 20 in the form of exterior surface gratings 22 on one or more planar portions of the exterior surface 12. Other aspects of the vehicular badge 100 include a badge member 10 with one or more diffraction gratings 20 in the form of interior surface gratings 24 on one or more planar portions of the interior surface 14.

In addition, as depicted in FIG. 2C, exterior and interior surfaces 12, 14 of the badge member 10 of the iridescent vehicular badge 100 can include one or more diffraction films 13, 15, each of which contains one or more diffraction gratings 20. The diffraction films 13, 15 may be in the form of a layer, foil, film or comparable structure that is joined or otherwise fabricated to be integral with the badge member 10. In addition, the diffraction films 13, 15 may be from about 0.1 mm to about 1 cm in thickness. Preferably, the diffraction films 13, 15 are between about 0.1 mm and 5 mm in thickness. Further, as also depicted in FIG. 2C, the diffraction films 13, 15 can comprise respective exterior and interior surface diffraction gratings 22, 24 located on planar portions of exterior and interior surfaces 12, 14, respectively. In some implementations, the badge member 10 contains only one diffraction film, either exterior diffraction film 13 or interior diffraction film 15.

As shown schematically in FIGS. 2B and 2D in cross-sectional form, the diffraction gratings 20 of the badge member 10 of an iridescent vehicular badge 100 (see FIG. 2) are formed at a microscopic level. In an embodiment, the diffraction gratings 20 (i.e., as inclusive of exterior and interior surface diffraction gratings 22, 24) have a thickness 38 that ranges from 250 nm to 1000 nm. The thickness 38 of the diffraction gratings 20, for example, should be maintained in the range of 250 to 1000 nm to ensure that the iridescent vehicular badge 100 (see FIGS. 2 and 2A) exhibits a jewel-like appearance through light diffraction upon illumination in direct ambient lighting while also having a minimal effect on the optical clarity of the badge 100 under non-direct ambient lighting. Preferably, the thickness 38 of the diffraction gratings 20 ranges from about 390 nm to 700 nm. In other embodiments, the thickness 38 of the diffraction gratings 20 ranges from 500 nm to 750 nm. Further, in some embodiments, crushed, reflective crystals (e.g., crushed silicate glass powder) are added to the diffraction gratings 20 to enhance or otherwise modify the jewel-like appearance of the gratings 20. Preferably, the crushed, reflective crystals are added to the diffraction gratings 20 when incorporated into diffraction films 13 and/or 15 (see FIGS. 2C and 2D).

As also shown schematically in FIGS. 2B and 2D, the grooves of the diffraction gratings 20 within the badge member 10 of an iridescent vehicular badge 100 can be configured in various shapes to diffract incident light and produce an iridescent and jewel-like appearance. As depicted in FIGS. 2B and 2D in exemplary form, the gratings 20 have a sawtooth or triangular shape. In three dimensions, these gratings 20 can appear with a stepped or sawtooth shape without angular features (i.e., in the direction normal to what is depicted in FIGS. 2B and 2D), pyramidal in shape, or some combination of stepped and pyramidal shapes. Other shapes of the diffraction gratings 20 include hill-shaped features (not shown)—e.g., stepped features with one or more curved features. The diffraction gratings 20 can also include portions with a combination of triangular and hill-shaped features. More generally, the shapes of the gratings 20 should be such that an effective blazing angle θ_{B} of at least 15 degrees is present for one or more portions of each grating, tooth or groove of the diffraction gratings 20. The blaze angle θ_{B} is the angle between step normal (i.e., the direction normal to each step or tooth of the grating 20) and the direction normal 40 to the exterior and interior surfaces 12, 14 having the grating 20.

Generally, the blaze angle θ_{B} is optimized to maximize the efficiency of the wavelength(s) of the incident light, typically ambient sunlight, to ensure that maximum optical power is concentrated in one or more diffraction orders while minimizing residual power in other orders (e.g., the zeroth order indicative of the ambient light itself). An advantage of situating exterior and interior surface diffraction gratings 22, 24 (see FIGS. 2A and 2C) on planar portions or aspects of the exterior and interior surfaces 12, 14 (e.g., as shown in exemplary form in FIGS. 2A and 2C for a diffraction grating 24 on a planar portion of an interior surface 14) is that a constant blaze angle θ_{B} and period 36 will result in consistent reflected and diffracted light produced from the diffraction grating. Such consistency can be employed by a designer of the iridescent vehicular badge 100 (see FIG. 2) to ensure that particular jewel-like effects are observable by individuals at different locations and distances from the badge 100.

As also shown schematically in FIGS. 2B and 2D, the diffraction gratings 20 of the badge member 10 of an iridescent vehicular badge 100 are characterized by one or more periods 36 (also known as din the standard nomenclature of diffraction gratings). In most aspects of the vehicular badge 100 (see FIG. 2), the period 36 of the diffraction grating 20 is maintained between about 50 nm and about 5 microns. In general, the maximum wavelength that a given diffraction grating 20 can diffract is equal to twice the period 36. Hence, a diffraction grating 20 with a period 36 that is maintained between about 50 nm and about 5 microns can diffract light in an optical range of 100 nm to about 10 microns. In a preferred embodiment, the period 36 of a diffraction grating 20 is maintained from about 150 nm to about 400 nm, ensuring that the grating 20 can efficiently diffract light in an optical range of about 300 nm to about 800 nm, roughly covering the visible spectrum.

Referring again to FIGS. 2B and 2D, an interior surface diffraction grating 24 along a portion of an interior surface 14 of a badge member 10 is depicted in exemplary form. Incident light 50 (typically ambient, sun light) at an incident angle α is directed against a sawtooth-shaped diffraction grating 24 having a thickness 38, a period 36 and a blaze angle θ_{B}. More particularly, a portion of the incident light 50 (preferably, a small portion) striking the grating 24 at an incident angle α is reflected as reflected light 50ᵣ at the same angle α, and the remaining portion of the incident light 50 is diffracted at particular wavelengths corresponding to diffracted light 60ₙ, 60ₙ₊₁, etc. at corresponding diffraction angles βₙ, βₙ₊₁, etc. The reflected light 50ᵣ is indicative of the zeroth order (i.e., n=0) and the diffracted light 60ₙ, 60ₙ₊₁, etc., are indicative of the nth order diffraction according to standard diffraction grating terminology, where n is an integer corresponding to particular wavelengths of the reflected or diffracted light.

Interior surface gratings 24, such as depicted in an enlarged, schematic format in FIGS. 2B and 2D, are advantageous within the iridescent vehicular badge 100 (see FIGS. 2, 2A and 2C) due to their protected location. In particular, these gratings 24 are generally protected from damage, alteration and/or wear due to their location on the backside of the badge member 10. Given that incident light 50 must pass through the member 10 to reach the grating 24 and that diffracted light 60ₙ, 60ₙ₊₁, etc., must also pass through the member 10 to produce an iridescent effect, the diffraction efficiency of gratings 24 can be somewhat lower than the diffraction efficiency of the exterior surface gratings 22 (see FIGS. 2A and 2C) due to light absorption within the member 10. On the other hand, exterior surface gratings 22, as configured within the exterior surface 12 of the member 10 are more susceptible to damage, alteration and/or wear than interior surface gratings 24. Accordingly, a preferred embodiment of the vehicular badge 100 includes both exterior and interior surface diffraction gratings 22, 24 to balance diffraction efficiency and wear resistance.

Referring to FIGS. 3-3D, an iridescent vehicular badge 100a comprising a translucent, polymeric badge member 10a with non-planar exterior and interior surfaces 12a, 14a is depicted according to an aspect of the disclosure. The iridescent vehicular badge 100a shown in FIGS. 3, 3A and 3C is similar to the iridescent vehicular badge 100 depicted in FIGS. 2, 2A and 2C, and like-numbered elements have the same structure and function. The primary difference between badges 100a and badges 100 is that the former have a badge member 10a with non-planar portions of interior and exterior surfaces 12a, 14a (or such surfaces 12a, 14a that are substantially non-planar across their entire surface area) and diffraction gratings 20a on such non-planar features (or within diffraction films 13a and/or 15a, as shown in FIG. 3C). In contrast, vehicular badges 100 have a badge member 10 with diffraction gratings 20 located on planar portions of exterior and interior surfaces 12, 14 (or within diffraction films 13 and/or 15, as shown in FIG. 2C). By situating the diffraction gratings 20a on non-planar portions of the interior and exterior surfaces 12a, 14a, certain jewel-like and iridescent effects can be obtained with badges 100a that differ from those obtained with badges 100. In all other respects, however, the iridescent vehicular badges 100 and 100a have the same structures and functions.

Referring to FIG. 3A, the iridescent vehicular badge 100a includes a badge member 10a with one or more diffraction gratings 20a. Further, diffraction gratings 20a include exterior and interior surface diffraction gratings 22a and 24a, respectively, located within or otherwise on non-planar portions of exterior and interior surfaces 12a, 14a of the member 10a. Some aspects of the vehicular badge 100a include a badge member 10a with one or more diffraction gratings 20a in the form of exterior surface gratings 22a on one or more non-planar portions of the exterior surface 12a. Other aspects of the vehicular badge 100a include a badge member 10a with one or more diffraction gratings 20a in the form of interior surface gratings 24a on one or more non-planar portions of the interior surface 14a.

In addition, as depicted in FIG. 3C, exterior and interior surfaces 12a, 14a of the badge member 10a of the iridescent vehicular badge 100a can include one or more diffraction films 13a, 15a, each of which contains one or more diffraction gratings 20a. The diffraction films 13a, 15a may be in the form of a layer, foil, film or comparable structure that is joined or otherwise fabricated to be integral with the badge member 10a. In addition, the diffraction films 13a, 15a may be from about 0.1 mm to about 1 cm in thickness. Preferably, the diffraction films 13a, 15a are between about 0.1 mm and 5 mm in thickness. Further, as also depicted in FIG. 3C, the diffraction films 13a, 15a can comprise respective exterior and interior surface diffraction gratings 22a, 24a located on non-planar portions of exterior and interior surfaces 12a, 14a, respectively. In some implementations, the badge member 10a contains only one diffraction film, either exterior diffraction film 13a or interior diffraction film 15a.

Referring now to FIGS. 3B and 3D, the cross-sectional view of the diffraction gratings 20a within the badge member 10a of an iridescent vehicular badge 100a is similar to the cross-sectional view of the diffraction gratings 20 in FIGS. 2B and 2D. In FIGS. 3B and 3D, incident light 50 (typically ambient, sun light) at an incident angle α is directed against a sawtooth-shaped diffraction grating 24a having a thickness 38, a period 36 and a blaze angle θ_{B} (some elements not shown specifically in FIGS. 3B and 3C, but see FIGS. 2B and 2D). More particularly, a portion of the incident light 50 (preferably, a small portion) striking the grating 24a at an incident angle α is reflected as reflected light 50ᵣ at the same angle α (some elements not shown specifically in FIGS. 3B and 3C, but see FIGS. 2B and 2D), and the remaining portion of the incident light 50 is diffracted at particular wavelengths corresponding to diffracted light 60ₙ, 60ₙ₊₁, etc., at corresponding diffraction angles βₙ and βₙ₊₁ (see FIGS. 2B and 2D) and so on. The reflected light 50ᵣ (see FIGS. 2B and 2D) is indicative of the zeroth order (i.e., n=0) and the diffracted light 60ₙ, 60ₙ₊₁, etc., are indicative of the nth order diffraction according to standard diffraction grating terminology, where n is an integer corresponding to particular wavelengths of the reflected or diffracted light. Given that the interior surface 14a is non-planar in the badge 10a depicted in FIGS. 3B and 3D, the incident light 50 strikes each tooth at a slightly different angle, even when the blaze angle θ_{B} (not shown in FIGS. 3B and 3D, but see FIGS. 2B and 2D) and period 36 is held constant. The result is that each tooth of the diffraction grating 20a can produce diffracted light at unique or differing diffraction orders. For example, as shown in FIGS. 3B and 3D, one tooth of the diffraction grating can produce diffracted light 60ₙ and 60ₙ₊₁ and a different tooth can produce diffracted light 60ₙ₊₂ and 60ₙ₊₃, all from the same incident light 50. Consequently, the interior surface diffraction grating 24a, and more generally diffraction gratings 20a, advantageously can produce jewel-like effects of widely varying wavelengths within small regions of the badge 100a (see FIGS. 3, 3A and 3C).

It should also be understood that, in some embodiments, crushed, reflective crystals (e.g., crushed silicate glass powder) can be added to the diffraction gratings 20a to enhance the jewel-like appearance of the gratings 20a. Preferably, the crushed, reflective crystals are added to the diffraction gratings 20a as they are incorporated, or otherwise formed, into the diffraction films 13a and/or 15a (see FIGS. 3C and 3D).

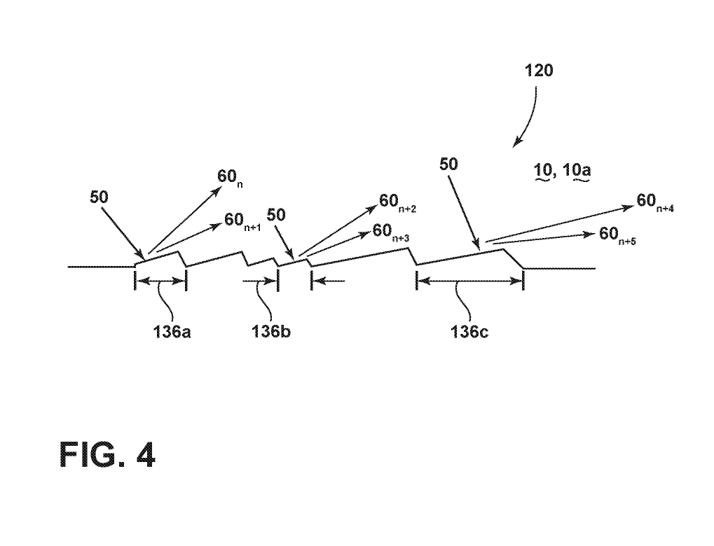

Referring now to FIG. 4, a diffraction grating 120 with varying periods (e.g., as including a set of periods), that can be employed in iridescent vehicular badges 100, 100a (or other badges consistent with the principles of the disclosure) is depicted in a cross-sectional form according to an aspect of the disclosure. The diffraction grating 120 is similar in most respects to the diffraction gratings 20, 20a depicted in FIGS. 2-2D and 3-3D, with like-numbered elements having the same structure and function. Diffraction grating 120 differs from diffraction gratings 20, 20a in that it contains varying periods within the same grating. In particular, diffraction grating 120 can have two or more sets of teeth or grooves, each having a particular period (e.g., period 136a) that can produce light at unique or differing diffraction orders. As shown in exemplary form in FIG. 4, the grating 120 is configured with three periods —period 136a, period 136b and period 136c. One set of teeth of the diffraction grating 120 with a period of 136a can produce diffracted light 60ₙ and 60ₙ₊₁, a different set of teeth with a period of 136b can produce diffracted light 60ₙ₊₂ and 60ₙ₊₃, and a third set of teeth with a period of 136c can produce diffracted light 60ₙ₊₄ and 60ₙ₊₅, all from the same incident light 50. Consequently, a diffraction grating 120, whether employed on interior and/or exterior surfaces 12, 12a, 14, 14a (see FIGS. 2A and 3A) of the member 10, 10a, (see FIGS. 2A, 2C, 3A and 3D) advantageously can produce jewel-like effects of widely varying wavelengths within various regions of the badge 100, 100a (see FIGS. 2A, 2C, 3A and 3C) containing such a grating.

In some aspects, the diffraction grating 120 includes a varying period that varies between two to ten discrete values or, more preferably, between two to five discrete values. According to another aspect, a diffraction grating 120 with varying periods can be employed in one or more portions of an exterior and/or interior surface 12, 12a, 14, 14a of a badge member 10, 10a, and one or more diffraction gratings 20, 20a having a constant period are employed in other portions of the exterior and/or interior surface of the badge member 10, 10a to create interesting, jewel-like appearance effects produced by the vehicular badge 100, 100a employing the gratings. In another embodiment, the diffraction grating 120 includes a varying period that changes between any number of values, only limited by the overall length of the grating 120 and/or the processing capabilities to develop such variability through precise control of mold dimensions.

Turning back toward iridescent vehicular badges 100, 100a more generally, optional coatings (not shown) may be applied over the exterior surfaces 12, 12a of the badge member 10, 10a. For example, an optically clear sealing layer (e.g., a polyurethane seal) can be applied over such exterior surfaces to add further mechanical and/or ultraviolet light protection to the badges 100, 100a, particularly to any diffraction gratings 20, 20a included in the exterior surfaces of these badges. Advantageously, the additional, relatively thin protective coating can protect the diffraction gratings while retaining the benefits of locating the grating on the exterior surface of the badge in terms of diffraction efficiency and the overall iridescence obtained by the badges 100, 100a.

In another aspect of the iridescent vehicular badges 100, 100a, an optional backing plate or backing layer can be applied to the interior surfaces 14, 14a of the badge members 10, 10a of these badges. Such a backing plate or layer can be specular (e.g., mirror-like) or non-specular (e.g., light-scattering), depending on the aesthetic effect desired of the badge 100, 100a. Similarly, the backing plate or layer can be white, grey, black or any conceivable color. For example, a badge designer could employ a red backing plate to produce a red-hued iridescence with a badge 100, 100a configured on the hood of a blue-colored vehicle possessing such a badge.

According to another aspect of the disclosure, a method of making an iridescent vehicle badge (e.g., iridescent vehicular badges 100, 100a) is provided that includes a step of forming a mold with mold surfaces corresponding to interior and exterior surfaces of the badge (e.g., exterior and interior surfaces 12, 12a, 14, 14a). Preferably, a mold is formed for this step from metals or metal alloys sufficient to withstand the temperatures and environmental conditions associated with injection molding a badge member (e.g., members 10, 10a) suitable for the iridescent vehicular badge. In a preferred embodiment, the forming a mold step is conducted such that the mold is capable of injection molding a single piece badge member 10, 10a.

The method of making an iridescent vehicular badge also includes a step of ablating at least one of the mold surfaces to form one or more diffraction grating mold surfaces. For example, the ablating step is conducted to form one or more such diffraction grating surfaces intended to correspond to diffraction gratings (e.g., gratings 20, 20a and 120) intended to be incorporated in portions of the exterior and/or interior surfaces of the badge (e.g., badges 100, 100a). In a preferred embodiment, the ablating step is conducted with a laser ablation process. Laser ablation processes, e.g., employing an AgieCharmilles Laser P cutting apparatus from Georg Fischer Ltd., are particularly adept at developing the diffraction grating mold surfaces in the mold given their ability to precisely ablate microscopic features into metal and metal alloy mold surfaces.

Referring again to the method of making the iridescent vehicular badge, it also includes a step of forming the badge (e.g., badges 100, 100a) with a diffraction grating (e.g., diffraction gratings 20, 20a, 120) having a thickness from 250 nm to 1000 nm and a period from 50 nm to 5 microns in the mold surfaces with a polymeric material (e.g., optically clear silicone with a high flow rate). Preferably, the forming the badge step is conducted with an injection molding process. In a preferred aspect, portions of the mold in proximity to the one or more diffraction grating mold surfaces are heated prior to the step of forming the badge. Adding additional heat to these portions of the mold serves to further reduce the viscosity of the polymeric material such that it can flow within the very small scale aspects of the diffraction grating mold surfaces.

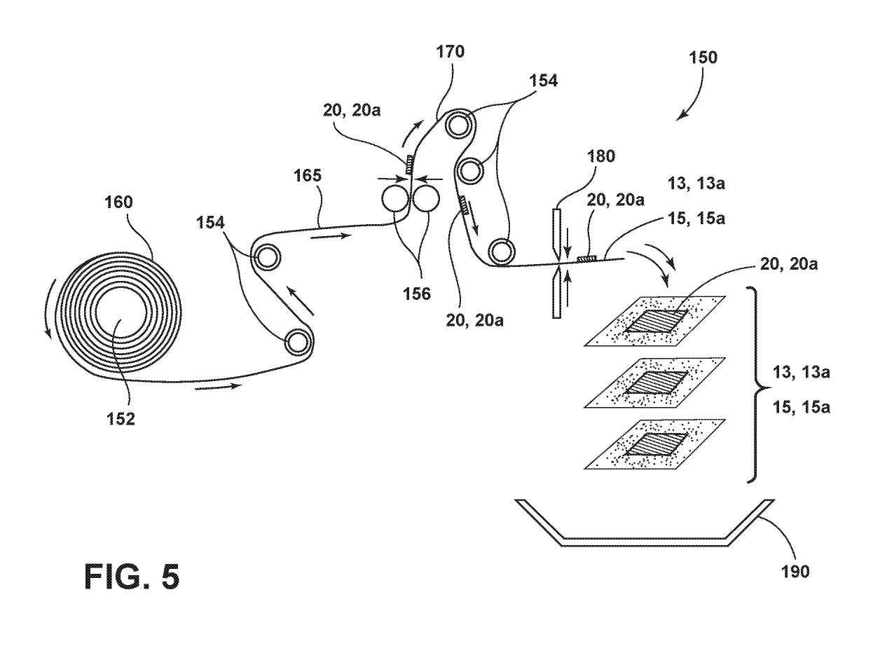

Referring now to FIG. 5, an embossing apparatus 150 is depicted in schematic form that can be employed to emboss diffraction gratings 20, 20a into a polymeric film to form diffraction films 13, 13a, 15, 15a. More particularly, a polymeric film 160 can be stored as shown on a spool 152. The polymeric film 160 can then be fed and routed through one or more pulling rollers 154. The pulling rollers 154 can then be employed to stretch and work the polymeric film 160 to remove wrinkles and other macroscopic defects. The resulting stretched polymeric film 165 can then be fed into a pair of embossing rollers 156 as shown. The embossing rollers 156 can be fabricated from a metal alloy. One or more of the embossing rollers 156 can be configured to press against the stretched polymeric film 165 to emboss diffraction gratings 20, 20a into the film, thus forming a polymeric film 170 with embossed diffraction gratings. Next, the polymeric film 170 containing the diffraction gratings 20, 20a is fed through one or more pulling rollers 154 to further stretch the film and remove other wrinkles or defects that have formed in the film, e.g., from the embossing step. Also, in some embodiments, crushed, reflective crystals (e.g., crushed silicate glass powder) can be added to the film, now containing diffraction gratings 20, 20a, to enhance or otherwise modify the jewel-like appearance of the gratings 20, 20a. Preferably, the crushed, reflective crystals are added to the diffraction gratings 20, 20a via the pulling rollers 154 and/or embossing rollers 156, during or before the gratings 20, 20a are incorporated into the stretched polymeric film 165 and, ultimately, the diffraction films 13, 13a, 15, 15a (see FIGS. 2C, 2D, 3C and 3D).

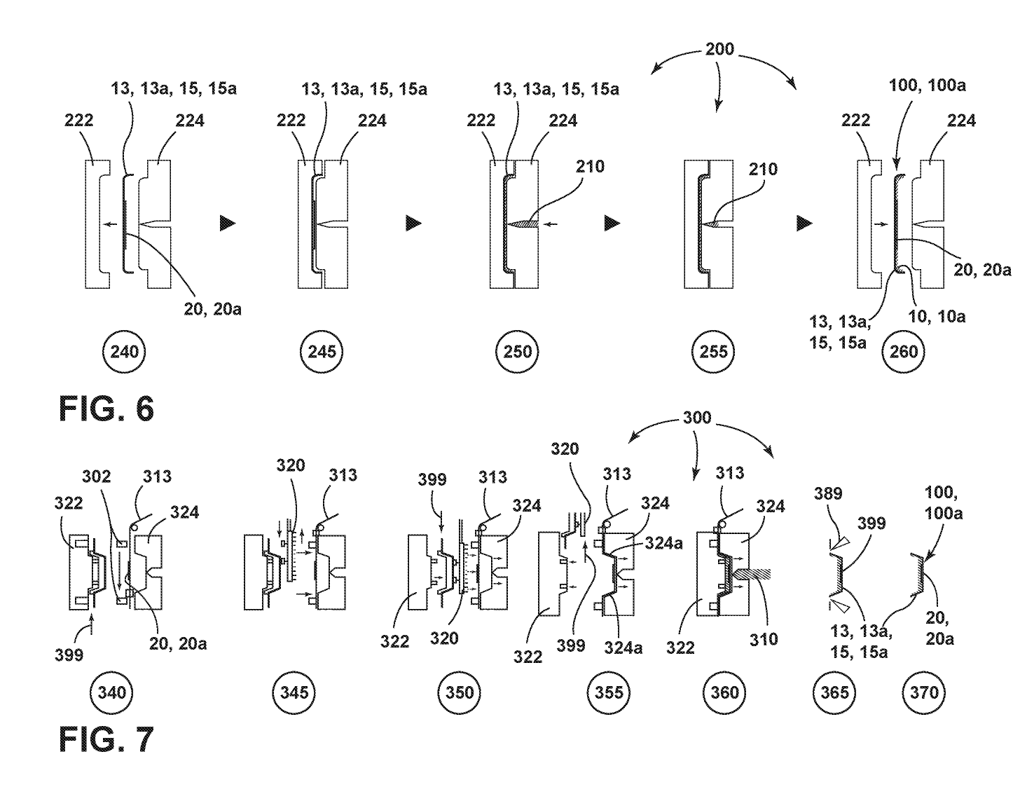

Finally, the stretched polymer film 170 containing the diffraction gratings 20, 20a may be sectioned with the die cut apparatus 180, and placed into a receptacle 190 as shown in FIG. 5. These sectioned films can serve as diffraction films 13, 13a, 15, 15a (see also FIGS. 2C and 3C). In some aspects, these diffraction films can be employed to fabricate iridescent vehicular badges 100, 100a using the insert molding process 200 outlined below (see FIG. 6). In other aspects, the polymeric film 170 with embossed diffraction gratings 20, 20a is not cut or sectioned within the embossing apparatus 150; instead, a continuous or semi-continuous film 170 with diffraction gratings 20, 20a can be routed as a film, e.g., film 313, into a mold to fabricate iridescent vehicular badges 100, 100a using a vacuum-assisted, inserting molding process 300 as also outlined below in FIG. 7.

Referring back to the embossing rollers 156 of the embossing apparatus 150 depicted in FIG. 5, one or more of these rollers can include a diffraction grating pattern. Preferably, the diffraction grating pattern is etched into the rollers with a laser-etching process. To the extent that the embossing apparatus 150 includes one or more embossing rollers 156 without diffraction grating patterns, these rollers that lack a diffraction grating pattern should be polished to a low surface roughness. More generally, the diffraction grating patterns configured on the embossing rollers 156 are the negative of the particular, desired diffraction grating 20, 20a intended to be embossed within the diffraction films 13, 13a, 15 and/or 15a. As the stretched polymer film 165 is routed through these rollers 156, the diffraction grating patterns on these rollers press against the film to emboss or otherwise impart the film with the desired diffraction gratings 20, 20a.

Referring again to the embossing apparatus 150 and its associated embossing process depicted in FIG. 5, this apparatus is merely an exemplary aspect of the disclosure. Other implementations of the disclosure are directed to variants of the embossing apparatus 150 and its associated embossing process. For example, the embossing apparatus 150 can include multiple sets of embossing rollers 156, some or all of which can include diffraction grating patterns for embossing diffraction gratings 20, 20a into the polymeric film 165. As another example, the embossing apparatus can include one or more heating elements to aid in the stretching operations effected by the pulling rollers 154. Such heating elements (e.g., convection heaters, infra-red heaters, or the like) can be placed in relatively close proximity to the film 165 or film 170 as it passes through the pulling rollers 154. Still further, some embodiments of the embossing apparatus 150 may include embossing rollers 156 capable of movement and adjustment, e.g., by a controller (not shown), for purposes of changing the location and/or structure associated with the diffraction gratings 20, 20a as they are embossed into the stretched polymeric film 165. More particularly, adjustable embossing rollers 156 can be moved to change the pressure and/or relative location of the diffraction grating patterns as they are employed to emboss the stretched polymeric film 170. In this way, unique diffraction gratings 20, 20a can be imparted into the stretched polymeric film 170 and ultimately formed into the diffraction films 13, 13a, 15, 15a.

Referring now to FIG. 6, an insert molding process 200 is depicted in schematic form for making an iridescent vehicular badge 100, 100a, e.g., as depicted in FIGS. 2-2D and 3-3D. In step 240, a diffraction film 13, 13a, 15, 15a (see FIGS. 2C and 3C) containing one or more diffraction gratings 20, 20a is positioned within two halves 222, 224 of a mold. As noted earlier, the diffraction film 13, 13a, 15, 15a can be formed from an embossing apparatus 150, as described earlier and depicted in FIG. 5. In step 245 of the insert molding process 200 the halves 222, 224 of the mold are closed over the diffraction film 13, 13a, 15, 15a, as shown. At this point, step 250 of the process 200 is initiated which involves injecting a polymeric material 210, preferably a translucent polymeric material, into the closed mold halves 222, 224 as shown. In some embodiments, the polymeric material 210 is a silicone, acrylic, polycarbonate or a combination of these materials. Further, in some aspects, the polymeric material 210 has the same or a similar composition as the polymeric material employed in the diffraction film 13, 13a, 15, 15a. Preferably, the polymeric material 210 is heated during and prior to the initiation of step 250 and injected into the mold halves 222, 224 under pressures above ambient pressure. Optionally, the mold halves 222, 224 are heated during and prior to the initiation of step 250. During step 250, the polymeric material 210 flows over the diffraction film 13, 13a, 15, 15a to form the badge member 10, 10a.

At this point of the insert molding process 200 depicted in FIG. 6, the mold halves 222, 224 surrounding the polymeric material 210 and the diffraction film 13, 13a, 15, 15a are now cooled during step 255. After cooling, the mold halves 222, 224 are opened, and the resulting iridescent badge 100, 100a (see also FIGS. 2-2D and 3-3D) is removed from the mold in step 260 (e.g., by a manual or a mechanical operation, such as with a robot arm having a suction apparatus). Further, as shown in FIG. 6 in step 260, the resulting iridescent vehicular badge 100, 100a includes a badge member 10, 10a and one or more diffraction films 13, 13a, 15, 15a comprising one or more diffraction gratings 20, 20a.

Referring again to the insert molding process 200 depicted in FIG. 6, this process, as outlined above, is merely an exemplary aspect of the disclosure. Other implementations of the disclosure are directed to variants of the insert molding process 200. For example, the insert molding process 200 can be conducted such that the diffraction film 13, 13a, 15, 15a is positioned on either or both of the surfaces associated with mold halves 222, 224 during step 240. Further, the mold halves 222, 224 can be configured such that either or both of them can be employed to inject polymeric material 210 into a cavity between the mold halves 222, 224 during step 250. As a result, various configurations of iridescent vehicular badges 100, 100a can be created with diffraction gratings 20, 20a on either or both of the exterior and interior surfaces 12, 12a, 24, 24a (see FIGS. 2A, 2C, 3A and 3C) with one or more variants of the insert molding process 200.

Referring now to FIG. 7, a vacuum-assisted insert molding process 300 is depicted in schematic form for making an iridescent vehicular badge 100, 100a, e.g., as depicted in FIGS. 2-2D and 3-3D. In step 340, a continuous or semi-continuous film 313 is fed into two mold halves 322, 324 with a plurality of rollers 302, fixtures or the like, as shown. The film 313 includes one or more diffraction gratings 20, 20a. In some embodiments, the film 313 is comparable in structure to the continuous or semi-continuous film 170 comprising a set of embossed diffraction gratings 20, 20a, such as prepared with the embossing apparatus 150 outlined earlier and depicted in FIG. 5. As also shown in step 340, an iridescent badge assembly 399 is depicted in an as-formed state, in contact with mold half 322. Referring now to step 345, a fixture 320 is positioned adjacent to the badge assembly 399 and the film 313. In some embodiments of the process 300, the fixture 320 can begin applying heat to the film 313 during step 345. In addition, the rollers 302 and/or fixture 320 may section away a portion of the film 313, such that the remaining film 313 section fits within the mold halves 322, 324.

At this point in the vacuum-assisted insert molding process 300 depicted in FIG. 7, the process moves to step 350. In step 350, the fixture 320 can secure the badge assembly 399 (e.g., as made earlier in a manufacturing operation that employs process 300) through suction, a temporary adhesive or other apparatus configured to temporarily secure the assembly 399. Also in step 350, the fixture 320 continues to apply heat to the film 313, e.g., with a temperature and time in view of the composition of film 313 such that it may readily experience plastic deformation. In addition, the mold half 324 can begin applying a vacuum force, suction or the like, e.g., through holes (not shown) in the mold half, to the film 313. The process continues toward step 355 in which the vacuum force continues against the film 313 such that the film deforms against the mold surface 324a, thus conforming to its surface. Also in step 355, the fixture 320 removes the badge assembly 399 away from the mold half 322 and upward away from both halves 322, 324. Note that the badge assembly 399 obtained from step 355 can be converted into a badge assembly 100, 100a by a trimming operation (not shown), such as the operation depicted in steps 365 and 370 (described in greater detail below).

Referring again to FIG. 7, the vacuum-assisted insert molding process 300 continues on to step 360. In this step, a polymeric material 310, preferably a translucent polymeric material, is injected through mold half 324 over the mold surface 324a into the closed mold halves 322, 324 as shown. In some embodiments, the polymeric material 310 is a silicone, acrylic, polycarbonate or a combination of these materials. Further, in some aspects, the polymeric material 310 has the same or a similar composition as the polymeric material employed in the film 313 containing diffraction gratings 20, 20a. Preferably, the polymeric material 310 is heated during and prior to the initiation of step 360 and injected into the mold halves 322, 324 under pressures above ambient pressure. Optionally, the mold halves 322, 324 are heated during and prior to the initiation of step 360. During step 360, the polymeric material 310 flows over the mold surface 324a and the film 313 containing the diffraction gratings 20, 20a to form a badge assembly (later defined as badge assembly 399 in step 365).

At this point of the vacuum-assisted insert molding process 300 depicted in FIG. 7 toward the end of step 360, the mold halves 322, 324 surrounding the polymeric material 310 and the film 313 containing diffraction gratings 20, 20a are cooled. After cooling, the mold halves 322, 324 are opened, and the resulting badge assembly 399 is removed from the mold (e.g., by a manual or a mechanical operation, such as with a robot arm having a suction apparatus) during step 365. Further, in step 365, remaining portions of the film 313 are removed from the badge assembly 399 by cutting elements 389 as shown, thus forming the iridescent badge 100, 100a (see also FIGS. 2-2D and 3-3D). As also shown in FIG. 7, the resulting iridescent vehicular badge 100, 100a includes a badge member 10, 10a and one or more diffraction films 13, 13a, 15, 15a comprising one or more diffraction gratings 20, 20a.

Once again referring to the vacuum-assisted insert molding process 300 depicted in FIG. 7, this process is merely an exemplary aspect of the disclosure. Other implementations of the disclosure are directed to variants of the process 300. For example, variants of the process 300 can rely on apparatus or manual operations other than those disclosed earlier in connection with fixture 320 to remove badge assemblies 399. It should also be apparent that the vacuum-assisted insert molding process 300 can be conducted such that the continuous or semi-continuous film 313 (e.g., as containing diffraction gratings 20, 20a) can be positioned on either or both of the surfaces associated with mold halves 322, 324 during step 340, for example. Further, the mold halves 322, 324 can be configured such that either or both of them can be employed to inject polymeric material 310 into a cavity between the mold halves 322, 324 during step 360. Likewise, either or both of the mold halves 322, 324 can be configured with holes, ports or the like, along with optional heating apparatus, such that a vacuum or negative pressure and/or heat can be applied to the film 313 during steps 350 and 355 to deform the film 313 and conform it to the surfaces of these mold halves 322, 324. As a result, various configurations of iridescent vehicular badges 100, 100a can be created with diffraction gratings 20, 20a on either or both of the exterior and interior surfaces 12, 12a, 24, 24a (see FIGS. 2A, 2C, 3A and 3C) using one or more variants of the vacuum-assisted insert molding process 300 of the disclosure.

Furthermore, the insert molding process 200 (e.g., as depicted in FIG. 6) or the vacuum-assisted insert molding process 300 (e.g., as depicted in FIG. 7), in combination with the use of an embossing apparatus 150 and its associated embossing process (see FIG. 5), each offer many advantages and benefits. For example, the costs associated with producing each of the iridescent vehicular badges 100, 100a with the insert molding processes 200, 300 are lower than the costs associated with an injection molding approach. One primary difference is that the capital costs are higher for etching, inscribing or otherwise creating diffraction patterns in an injection mold as compared to diffraction patterns in embossing rollers. In addition, the injection molding process often requires the use of lower viscosity polymeric materials to ensure proper flow within the diffraction patterns in the mold. Conversely, the insert molding processes 200, 300 do not have such challenges as the diffraction gratings are preferably embossed into a film, and the film is essentially adhered or integrated within the badge member during the insert molding process. As the insert molding process does not have the technical challenge of ensuring polymer flow into a diffraction pattern through viscosity and temperature control, among other factors, its yields will likely be higher than those associated with an injection molding process. These yield differences also result in lower manufacturing costs associated with the insert molding processes 200, 300.

According to other aspects of the disclosure, the concepts of the foregoing iridescent vehicular badges 100, 100a can be applied to other iridescent vehicular elements. These elements include exterior and interior vehicle trim features and elements, license plate holders, hubcaps, key bezels and any other feature that might benefit from iridescent appearance effects under ambient lighting, for example. It is also feasible to employ molds for the creation of such iridescent vehicular elements that can produce one-of-a-kind or near one-of-a-kind jewel-like appearance effects. For example, an iridescent vehicular badge 100, 100a can be designed for a mold with a fully-symmetric badge member having one or more symmetrically positioned diffraction grating(s) that diffract light differently in each direction. Once a given badge has been created, the random orientation associated with a manual or robot-driven installation on a vehicle can create a one-of-a-kind or near one-of-a-kind jewel-like appearance.

In a further aspect, iridescent vehicular badges 100, 100a can be configured with diffraction gratings 20, 20a such that they produce an iridescent appearance under day-time, ambient illumination while balancing the reduction of sparkle and glare for oncoming drivers under day-time or night-time conditions. Notably, diffraction gratings 20, 20a can be placed within certain locations of the exterior and/or interior surfaces 12, 12a, 14, 14a to produce the desired jewel-like appearance, but only when observers are located in positions not typical of oncoming vehicles.

Variations and modifications can be made to the aforementioned structure without departing from the concepts of the present invention. Such variations and modifications, and other embodiments understood by those with skill in the field within the scope of the disclosure, are intended to be covered by the following claims unless these claims by their language expressly state otherwise.

What is claimed is:

1. An iridescent vehicular badge, comprising:
a translucent, polymeric badge comprising interior and exterior surfaces, the badge formed from multiple parts,
wherein at least one of the surfaces is planar or non-planar and comprises a diffraction grating, the diffraction grating having a thickness from 250 nm to 1000 nm and a period from 50 nm to 5 microns.

2. The badge according to claim 1, wherein the multiple parts comprise a badge member and a diffraction film.

3. The badge according to claim 2, wherein the interior surface comprises a first diffraction film and the exterior surface comprises a second diffraction film, each diffraction film comprising a plurality of diffraction gratings.

4. The badge according to claim 2, wherein the interior surface comprises the diffraction film.

5. The badge according to claim 2, wherein the exterior surface comprises the diffraction film.

6. The badge according to claim 2, wherein the diffraction film further comprises crushed reflective crystals.

7. The badge according to claim 2, wherein the polymeric badge is tinted.

8. The badge according to claim 2, wherein the diffraction film is formed by embossing, and the badge member and diffraction film are joined by insert molding.

9. A method of making an iridescent vehicular badge, comprising:
embossing a diffraction grating into a polymeric film to form a diffraction film;
positioning the diffraction film in a mold; and
injecting a translucent polymeric material into the mold over the diffraction film to form a vehicular badge,
wherein the diffraction grating has a thickness from 250 nm to 1000 nm and a period from 50 nm to 5 microns.

10. The method according to claim 9, wherein the embossing is conducted with one or more embossing rollers, each of the embossing rollers comprising a laser-etched diffraction grating pattern.

11. The method according to claim 9, wherein the polymeric film and the translucent polymeric material have the same or similar compositions.

12. The method according to claim 9, wherein the diffraction film and the polymeric material are heated during the injection step.

13. The method according to claim 9, wherein the translucent polymeric material is selected from the group consisting of silicones, acrylics and polycarbonates.

14. The method according to claim 9, wherein the embossing step further comprises pressing a plurality of crushed, reflective crystals into the diffraction film.

15. A method of making an iridescent vehicular badge, comprising:
heating a diffraction film positioned in a mold;
applying a vacuum to form the film against a mold surface; and
injecting a translucent polymeric material over the mold surface to form a vehicular badge,
wherein the diffraction film comprises a polymeric material and a diffraction grating having a thickness from 250 nm to 1000 nm and a period from 50 nm to 5 microns.

16. The method according to claim 15, further comprising:
embossing a diffraction grating into a polymeric film to form the diffraction film.

17. The method according to claim 16, wherein the embossing is conducted with one or more embossing rollers, each of the embossing rollers comprising a laser-etched diffraction grating pattern.

18. The method according to claim 16, wherein the embossing step further comprises pressing a plurality of crushed, reflective crystals into the diffraction film.

19. The method according to claim 15, wherein the diffraction film and the polymeric material are heated during the injection step.

20. The method according to claim 15, wherein the translucent polymeric material is selected from the group consisting of silicones, acrylics and polycarbonates.
